(19) United States
(12) Patent Application Publication
(10) Pub. No.: US 2014/0267888 A1
(43) Pub. Date: Sep. 18, 2014

(54) Thermal Dissipating Device for Image Acquisition Unit

(71) Applicant: D-MAX TECHNOLOGY CO., LTD., New Taipei City (TW)

(72) Inventor: CHIANG-HAN CHEN, New Taipei City (TW)

(73) Assignee: D-MAX TECHNOLOGY CO., LTD., New Taipei City (TW)

(21) Appl. No.: 13/798,791

(22) Filed: Mar. 13, 2013

(51) Int. Cl. H04N 5/225

(52) U.S. Cl. CPC H04N 5/2251
USPC 348/373

(57) ABSTRACT

A thermal dissipating device for image acquisition unit is provided. The thermal dissipating device comprises a base plate, at least one image acquisition unit and at least one heat sink. The base plate has a first face and a second face opposite to the first face. The image acquisition unit is disposed on the first face and electrically connected to the base plate. The heat sink has an opening contacting the periphery of the image acquisition unit, to receive the image acquisition unit. In this manner, the working temperature of the image acquisition unit may be kept at sustainable level; thus the operation noise is therefore reduced and the lifetime is also prolonged.

### BACKGROUND OF THE INVENTION

1. Field of the Invention

The present invention relates to an image acquisition unit, particularly to a thermal dissipating device for image acquisition unit equipped with the function of higher thermal dissipation rate.

2. Description of Related Art

Currently, the digital picture-taken device such as digital image camera or video camera normally record the light and color variation by the Charge Coupled Device (CCD), in which the CCD is a semiconductor to detect the light and color by its millions of photo sensing components. In this manner, each photo sensing component dedicates to a pixel, and therefore the level of the camera is absolutely depended on the amount of the pixels; hence more pixels may result higher dpi (dots per inch). Conventionally, the photo sensing components are arranged as array and disposed at the surface of the CCD, which may response to the light variation and thus emerge the electric charge. If the electric charges are correspondingly detected and recorded, the millions of distinct charge value may be analyzed to construct a whole picture.

Complementary Metal Oxide Semiconductor (CMOS) is another semiconductor device to record the light variation. COMS has similar fabrication with computer chip, which is composed of silicon (Si) and germanium (Ge), to simultaneously has N pole (i.e. negative charge) and P pole (i.e. positive charge) flowing around. The movement of the P pole and N pole, namely complementary effect, may therefore be recorded and analyzed by the processing chip; thus the image or video may also be achieved.

However, the utilization of the CMOS and CCD may exploit power along with the frequently change of the electric current, and therefore generate heat; in worse, more pixels bring more heat. In this manner, higher heat may result higher noise. So how to dissipate the waste heat is an urgent problem needs to be settled.

### SUMMARY OF THE INVENTION

The primary object of present invention is to have a thermal dissipating device for image acquisition unit equipped with the function of higher thermal dissipation rate.

Another object of the present invention is to provide a thermal dissipating device for image acquisition unit with less operation noise and longer lifetime.

To achieve the above purpose, a thermal dissipating device for image acquisition unit is provided. The thermal dissipating device comprises a base plate, at least one image acquisition unit and at least one heat sink. The base plate has a first face and a second face opposite to the first face. The image acquisition unit is disposed on the first face and electrically connected to the base plate. The heat sink has an opening contacting the periphery of the image acquisition unit, to receive the image acquisition unit.

According to one embodiment of the thermal dissipating device for image acquisition unit, wherein the image acquisition unit is a camera module and has sensing side and a bottom side, wherein the bottom side neighbors and approaches to the first side of the base plate.

According to one embodiment of the thermal dissipating device for image acquisition unit, wherein the opening has a first edge, a second edge, a third edge opposite to the first edge, and a fourth edge opposite to the second edge, wherein the first edge, second edge, third edge and fourth edge link together and form a heat absorbing portion.

According to one embodiment of the thermal dissipating device for image acquisition unit, wherein the heat sink has a heat delivering portion attaches to the first face and extends outward from a departed location of the heat absorbing portion.

According to one embodiment of the thermal dissipating device for image acquisition unit, wherein the thermal dissipating device is utilized in an electrical product, and one side of the heat delivering portion is attached to the interior of the electrical product.

According to one embodiment of the thermal dissipating device for image acquisition unit, wherein the electrical product has a plurality of ventilation holes disposed at and passed through the exterior of the electrical product, wherein the ventilation holes correspond to the heat sink and the base plate.

As a result, the thermal dissipating device for image acquisition unit may have higher thermal dissipating rate, so that the electrical product with the image acquisition unit hence has less operation noise and longer lifetime.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 is a schematic view of the first embodiment of the present invention;

FIG. 2 is an explosive view of the first embodiment of the present invention;

FIG. 3 is an explosive view of the second embodiment of the present invention;

FIG. 4 is an explosive view of the third embodiment of the present invention.

### DETAILED DESCRIPTION OF THE PREFERRED EMBODIMENTS

Please refer to FIG. 1 and FIG. 2, FIG. 1 is a schematic view of the first embodiment of the present invention, FIG. 2 is an explosive view of the first embodiment of the present invention. In this embodiment, a thermal dissipating device 1 for image acquisition unit 11 is addressed. The thermal dissipating device 1 comprises a base plate 10, at least one image acquisition unit 11 and at least one heat sink 12. In the preferred case, the base plate 10 could be a circuit board, Printed Circuit Board (PCB), similar flexible board or composite materials board, etc. The base plate 10 may further contain some other kinds of boards without any limitation.

The base plate 10 has a first face 101 and a second face 102, in which the first face 101 is opposite to the second face 102. The base plate 10 further has a plurality of electrical components 2 disposed on. The electrical components 2 may be chip, transistor or passive components, which are electrically connected to the base plate 10. Besides, the image acquisition unit 11 may be a camera module disposed on the first face 101 of the base plate 10. The adjacent electrical components 2 may process the received signal of taken picture, image or video. The image acquisition unit 11 is electrically connected to the base plate 10, and has a sensing side 111 and a bottom side 112; in which the bottom side 112 is attached neighbor to the first face 101 of the base plate 10.

Moreover, the heat sink 12 has an opening 125 contacting and attaching the periphery of the image acquisition unit 11, in order to receive the image acquisition unit 11. Detailed description, the opening 125 has a first edge 121, a second edge 122, a third edge 123 and a fourth edge 124; in which the third edge 123 is opposite to the first edge 121, and the fourth edge 124 is opposite to the second edge 122. Besides, the first edge 121, second edge 122, third edge 123 and fourth edge 124 are linked together and formed a heat absorbing portion 127. The heat absorbing portion 127 may rapidly absorb the waste heat generated from the image acquisition unit 11.

Further referring the FIG. 1 and FIG. 2, the heat sink 12 has a heat delivering portion 128 attaching to the first face 101; moreover, the heat delivering portion 128 extends outward from a departed location (distance away from the opening 125) of the heat absorbing portion 127. In the embodiment, the heat delivering portion 128 is adjacent to and approached to the pluralities of electrical components 2 by its lower surface. In this manner, the heat absorbing portion 127 of the heat sink 12 may receive and then rapidly diffuse the heat to the heat delivering portion 128 when the image acquisition unit 11 generates more and more heat. In the meantime, the lower surface of the heat delivering portion 128 might simultaneously absorb heat generated form the adjacent electrical components 2, and then diffuse the energy to the upper surface of the heat delivering portion 128. Thus, the upper surface of the heat delivering portion 128 is taken advantage of its larger area, in order to achieve uniform and rapid thermal diffusion. Therefore the image acquisition unit 11 may have quick thermal dissipating rate by utilizing the heat sink 12, so that the electrical components 2 or the image acquisition unit 11 on the base plate 10 will not have unbearable temperature.

Summarily, the present invention utilizes the heat sink 12 disposing around the periphery of the image acquisition unit 11, which may effectively and efficiently achieve higher thermal dissipating rate, to rapidly cool down the temperature of the image acquisition unit 11 and base plate 10. So that the working temperature of the image acquisition unit 11 may be kept at sustainable level; thus the operation noise of the image acquisition unit 11 is therefore reduced and the lifetime is also prolonged.

Please refer to FIG. 3 as well as referring to FIG. 1 and FIG. 2;

FIG. 3 is an explosive view of the second embodiment of the present invention. The embodiment has shown that the thermal dissipation device 1 of the image acquisition unit 11 may be utilized in an electrical product 3 such as tablet PC, laptop, Personal Digital Assistant (PDA), smart phone, etc. In the embodiment, the thermal dissipating device 1 and the image acquisition unit 11 are disposed at interior of the electrical product 3, and the upper side of the heat delivering portion 128 is attached to the interior of the electrical product 3. In this manner, the heat delivering portion 128 may uniformly absorb the heat form the heat absorbing portion 127, and then deliver the energy to the attached electrical product 3. By means of larger area, the electrical product 3 may utilize its thermal diffusion surface to rapidly dissipate the waste heat, so that the working temperature of the image acquisition unit 11 may be kept at sustainable level, the operation noise of the image acquisition unit 11 is therefore reduced, and the lifetime is also prolonged.

Please refer to FIG. 4, as well as referring to FIG. 1 and FIG. 2; FIG. 4 is an explosive view of the third embodiment of the present invention. In the embodiment, the electrical product 3 has a plurality of ventilation holes 31; the ventilation holes 31 are disposed at the exterior face of the electrical product 3 and faced outward. Besides, the ventilation holes 31 are corresponded to the heat sink 12 and the base plate 10. In this manner, the pluralities of ventilation holes 31 may push ahead thermal dissipation of the heat sink 12, base plate 10 and some other elements (e.g. graphics processing chip or micro-processor) inside the electrical product 3 by means of the ventilation holes 31; therefore the waste heat generated inside the electrical product 3 may be exhausted from the ventilation holes 31 (by convection or radiation).

Summarily, the thermal dissipating device for image acquisition unit of the present invention has the following benefits:

1. The image acquisition unit 11 and base plate 10 may achieve better thermal dissipation;

2. The image acquisition unit 11 may reduce its operation noise;

3. The image acquisition unit 11 may have longer lifetime to use.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. A thermal dissipating device for image acquisition unit, comprising:
a base plate, having a first face and a second face opposite to the first face;
at least one image acquisition unit, disposing on the first face and electrically connecting to the base plate; and
at least one heat sink, having an opening contacting the periphery of the image acquisition unit, to receive the image acquisition unit.

2. The thermal dissipating device for image acquisition unit as claimed in claim 1, wherein the image acquisition unit is a camera module and has sensing side and a bottom side, wherein the bottom side neighbors and approaches to the first side of the base plate.

3. The thermal dissipating device for image acquisition unit as claimed in claim 2, wherein the opening has a first edge, a second edge, a third edge opposite to the first edge, and a fourth edge opposite to the second edge, wherein the first edge, second edge, third edge and fourth edge link together and form a heat absorbing portion.

4. The thermal dissipating device for image acquisition unit as claimed in claim 3, wherein the heat sink has a heat delivering portion attaches to the first face and extends outward from a departed location of the heat absorbing portion.

5. The thermal dissipating device for image acquisition unit as claimed in claim 4, wherein the thermal dissipating device is utilized in an electrical product, and one side of the heat delivering portion is attached to the interior of the electrical product.

6. The thermal dissipating device for image acquisition unit as claimed in claim 5, wherein the electrical product has a plurality of ventilation holes disposed at the exterior face of the electrical product, wherein the ventilation holes correspond to the heat sink and the base plate.
